(19) United States
(12) Patent Application Publication
(10) Pub. No.: US 2009/0319589 A1
(43) Pub. Date: Dec. 24, 2009

(54) USING FRACTIONAL EXPONENTS TO REDUCE THE COMPUTATIONAL COMPLEXITY OF NUMERICAL OPERATIONS

(75) Inventors: Marc Holder Kluver, Snohomish, WA (US); Xiaoqin Sun, Redmond, WA (US); Chao He, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,761

(22) Filed: Jun. 21, 2008

(51) Int. Cl. G06F 7/00; G06F 7/556

(52) U.S. Cl. 708/204; 708/517

(57) ABSTRACT

Technologies are described herein for using efficient log-linear transformations to reduce the complexity of numerical computations. Efficient transforms can convert between linear fixed point values and log space values in about ten processor cycles per sample. A fractional exponent and an integer exponent may be combined together into a log domain variable representation. Log domain arithmetic operations may be performed on the combined variable as a whole. A fractional exponent representation of log domain numerical values can support automatic bit carries from the fractional exponent into the integer exponent. If an intermediate result of a calculation in the log domain causes the fractional portion of the exponent to exceed one, a bit carry can occur over to the integer component of the exponent. This carry can occur automatically due to the conjoined placement of the integer and fractional components of the exponent in the log domain combined variable.

### BACKGROUND

Certain numerical operations require many computer cycles to perform. This is particularly true with respect to computers lacking hardware support for floating point operations. For example, microcontrollers, processor cores, fixed point microprocessors, application specific integrated circuits (ASICs) or fixed point digital signal processing (DSP) units may require special fixed point software implementations for computing certain numerical operations. Examples of such operations are the square root, division, multiplication, or exponentiation.

Using previous methods, a fixed point divide can take around 1000 processor cycles and a square root, using Newtonian recursion, can take around 5000 processor cycles. Such computation costs may preclude the use of fixed point processing systems in numerically intensive signal processing or communication applications particularly where real-time performance is required. This is unfortunate, since simpler fixed point processing hardware is generally smaller, cheaper, and consumes less power. All of these characteristics are desirable in modern, mobile, battery-powered applications.

Transforming numerical values into a logarithmic (log) domain can simplify some processor intensive calculations. In the log domain, a square root of a value can be performed by dividing the value by two, which is merely a right bit shift. Division of two values can be performed by simply subtracting the log domain representation of the two values. Similarly, multiplication is performed by adding the log domain values of the factors. Therefore converting to log domain can support the simplification of certain numerical operations. Unfortunately, traditional techniques for converting a value into the log domain involve a divide operation to scale the value into the proper dynamic range. After such a conversion, the number is generally represented as two separate values. One is a log value and the second is a scaling value. Since the traditional log conversation can use scaling, division, and a representation in two separate values, it is generally not useful for optimizing divide operations. Also, the high complexity of the divide makes the traditional log conversion of marginal use in calculating square roots.

It is with respect to these considerations and others that the disclosure made herein is presented.

### SUMMARY

Technologies are described herein for reducing the complexity of certain numerical computations using efficient log domain transformations. In particular, a fractional exponent representation of log domain numerical values can support automatic bit carries from the fractional exponent into the integer exponent. Efficient transforms can convert between fixed point values and the fractional exponent representations in about ten processor cycles per sample.

According to one aspect presented herein, conversion algorithms between fixed point numerical values and fractional exponent representations of those values can support efficient transformations into and out of the log domain from the linear domain. Significant reductions in computational complexity can be achieved by converting fixed point values into the log domain, performing multiple calculations in the log domain, and then converting any appropriate return values back to the fixed point domain.

According to another aspect presented herein, a fractional exponent and an integer exponent may be combined together into a new variable representation. Log domain arithmetic operations may be performed on the new combined variable as a whole. The fractional portion of the exponent may be used to represent a value from zero to one. If an intermediate result of a calculation in the log domain causes the fractional portion of the exponent to go negative, a bit borrow can occur from the integer component of the exponent automatically. This borrow can be achieved thanks to the conjoined placement of the integer and fractional components into a single value. Likewise, if an intermediate result causes the fractional part of the exponent to exceed one, a carry can automatically occur into the integer component of the exponent.

According to yet another aspect presented herein, numerical transformation algorithms for converting between linear space and fractional exponent log space can be efficiently implemented in a fixed point processing unit. The algorithms may use small lookup tables and can compute the transforms in approximately ten cycles per sample. These algorithms can be used in signal processing or communications systems for supporting features such as gain, pattern matching, or normalized correlation with reduced computational complexity while achieving excellent numerical accuracy.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating an operating environment for one embodiment presented herein;

FIG. 2 is a block diagram illustrating a signal flow between fixed point and fractional exponent numerical domains according to an embodiment presented herein;

FIG. 3 is a logical flow diagram illustrating a process for representing values in a fractional exponent domain according to an embodiment presented herein;

FIG. 4 is a logical flow diagram illustrating a process for transforming fixed point values into fractional exponent values according to an embodiment presented herein; and

FIG. 5 is a logical flow diagram illustrating a process for transforming fractional exponent values into fixed point values according to an embodiment presented herein.

### DETAILED DESCRIPTION

The following detailed description is directed to technologies for using fractional exponent representations of numerical values to reduce the computational complexity of numerical operations. Through the use of the technologies and concepts presented herein, fixed point values may be efficiently transformed into a fractional exponent domain where certain numerical operations can be computed with reduced complexity. Resultant values may be efficiently transformed back into their fixed point representation as appropriate.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for using fractional exponent representations of values to reduce the computational complexity of numerical operations will be described.

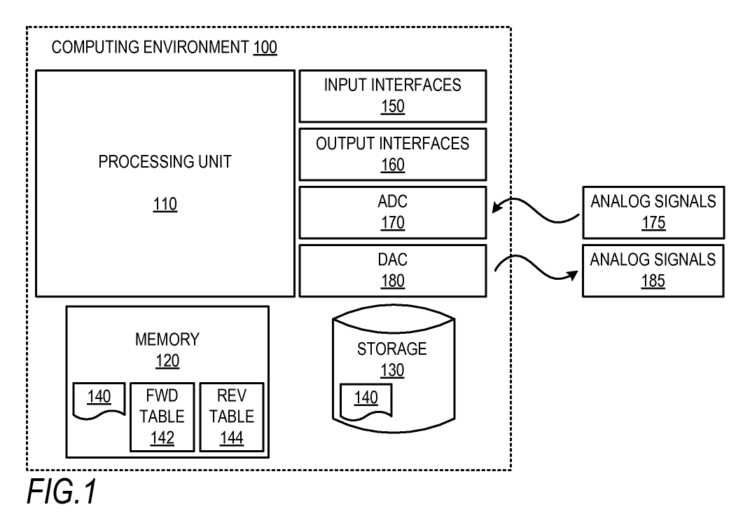

Turning now to FIG. 1, details will be provided regarding an illustrative computing environment that may be used to implement the embodiments presented herein. In particular, FIG. 1 shows a block diagram illustrating a computing environment 100, in accordance with exemplary embodiments. The computing environment 100 can include a processing unit 110, memory 120, storage 130, and various interfaces. The computing environment 100 can represent a computing system for signal processing, communications, embedded computing, or any of various systems using fixed point numerical operations.

The processing unit 110 may be a microprocessor, microcontroller, digital signal processor (DSP), application specific integrated circuit (ASIC), field programmable gate array (FPGA), system on chip (SOC), processing core, multi-processor array, dedicated digital circuitry, or any other form of logical processing device. The storage 130 may be a mass storage device, a read only memory (ROM), programmable read only memory (PROM), erasable programmable read only memory (EPROM), FLASH memory, optical storage, magnetic storage, semiconductor storage, CD-ROM, digital versatile disks (DVD), HD-DVD, BLU-RAY, magnetic cassettes, magnetic tape, magnetic disk storage, or any other medium which can be used to store information and which can be accessed by the processing unit 110. In other words, the storage 130 may be any computer-readable medium. Such computer-readable medium may be used for storing an operating system or any other program modules, computer-readable instructions, data structures, program modules or other data.

The memory 120 can be random access memory (RAM) or any other memory used during the operation of the processing unit 110. The memory 120 may be used for storing data or programs, or program modules, or computer-readable instructions. The memory 120 may be another example of a computer-readable medium. A computer program or program module 140 may be executed from the storage 130. For example, the program or module 140 may be loaded, or booted, into memory 120. A forward lookup table 142 and a reverse lookup table 144 may be stored in the memory 120 for use with the programs or modules 140 as discussed herein.

Programs or modules 140 may operate to perform the methods described herein. The programs or modules 140 may reside and execute in whole, or in part, on a system implementing digital signal processing functions, communication functions, or various other applications involving numerical operations. The programs or modules 140 may reside and execute in a distributed fashion over various computing devices within a system.

Output interfaces 160 associated with the processing unit 110 may support video displays, audio speakers, network interfaces, projectors, printers, illuminated indicators, buzzers, voice synthesizers, transmitters, or any other device used to output information, data, or signals from the processing unit 110 to any other entity such as a user, a network, a system bus, another processing unit 110, a storage system, another computing environment 100, or otherwise.

Input interfaces 150 associated with the processing unit 110 may support keyboards, mice, cameras, video scanners, sheet scanners, barcode readers, card readers, radio receivers, infrared receivers, microphones, buttons, control knobs, potentiometers, joysticks, trackballs, receivers, or any other device used to input information, data, or signals to the processing unit 110 from any other entity such as a user, a network, a system bus, another processing unit 110, a storage system, another computing environment 100, or otherwise.

An analog to digital converter (ADC) 170 may be used as a specific input interface for sampling analog signals 175 into discrete or digital values to be stored in memory 120 and/or manipulated by the processing unit 110. Example analog signals for sampling may relate to audio, music, speech, images, video, communication signals, radio frequency (RF) energy, radio signals, intermediate frequency (IF) radio signals, baseband radio signals, light, modulated light, radar, sonar, any other analog signal, or any combination thereof.

A digital to analog converter (DAC) 180 may be used as a specific output interface for filtering discrete or digital values from the memory 120 or the processing unit 110 into analog signals 185 to be output from the system. An example use of an ADC 170 and a DAC 180 in a mobile telephony application may be seen in the audio interfaces. For instance, signals from a microphone of a mobile handset may be sampled by an ADC 170 and stored in the memory 120 for processing and transmission as RF energy. Similarly, a received RF signal may be processed and then converted by a DAC 180 into an analog signal that can drive a speaker of the handset. In such a system, another ADC 170 and DAC 180 pair may be used to drive and receive the radio signal from the processing unit 110 into the RF or radio transceiver blocks of the handset. While in the digital domain, these various signals may be stored as fixed point value. Various calculations may be performed on these fixed point values to manipulate, code, decode, classify, filter, convert, compress, decompress, encrypt, decrypt, correlate, modulate, demodulate, equalize, normalize, or otherwise process these fixed point representations of the various signals. These calculations can be examples of those addressed herein for complexity reduction through efficient transformation into the log domain using a fractional exponent numerical representation.

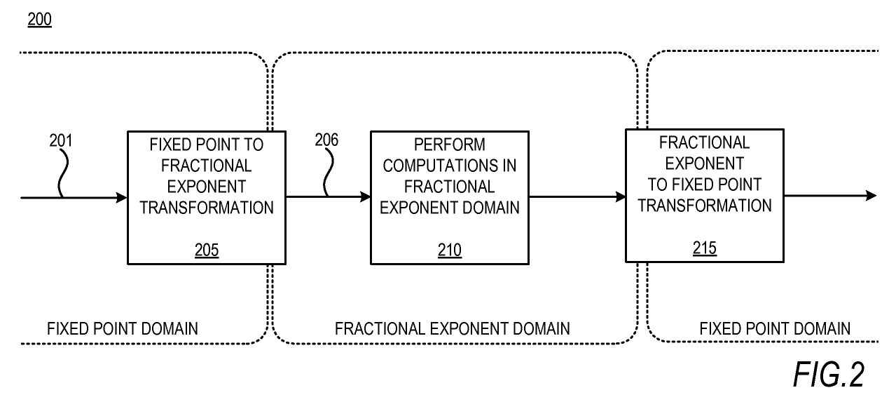

Turning now to FIG. 2, additional details will be provided regarding the embodiments presented herein for using fractional exponent representations of values to reduce the computational complexity of numerical operations. In particular, FIG. 2 shows a block diagram 200 illustrating a signal flow between fixed point and fractional exponent numerical domains in accordance with exemplary embodiments.

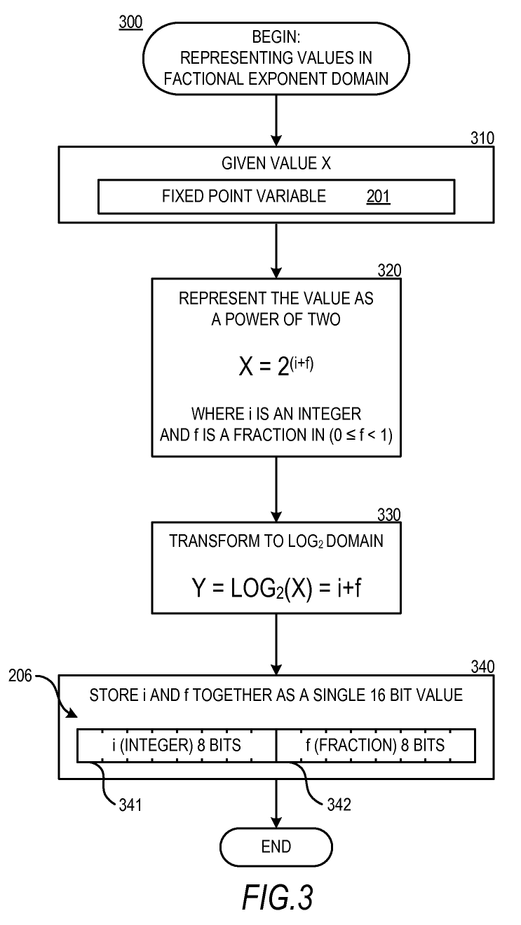

Values stored in or entering the computing environment 100 may be stored in a fixed point numerical representation. A fixed point number 201 can represent a real numerical value, but may be limited to a fixed number of digits beyond the decimal point. In module 205, fixed point values 201 may be converted to a log domain fractional exponent representation 206 using a fractional exponent transformation process 400. The fractional exponent representation 206 can be a log domain value given by a specially formatted twos compliment fractional exponent representation. This representation is discussed in further detail with respect to FIG. 3.

In module 210, log space values 206 in the fractional exponent domain can support the computation of certain numerical operations with improved efficiently. For example, division can be carried out as a subtraction and a square root can be carried out as a left bit-shift. Other computations such as multiplication and exponentiation can also be carried out with reduced computational complexity in the log space.

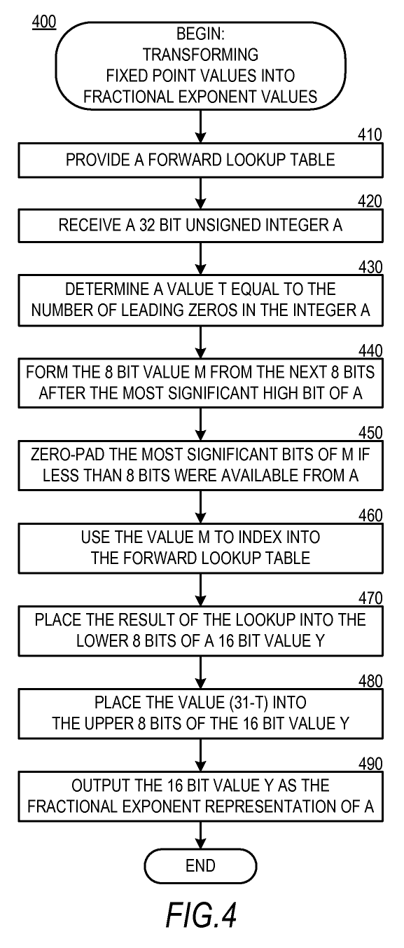

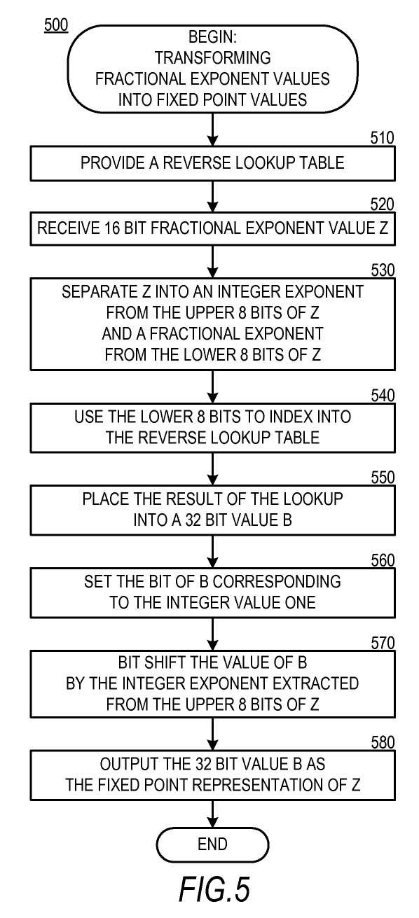

In module 215, any required resultant values can be converted from the log space back to the fixed point domain using an efficient fractional exponent to fixed point transformation process 500. Converting fixed point values into a log domain fractional exponent representation can support log space computations with reduced computational complexity. A net reduction in complexity can be realized when reduction in computational complexity due to in the log space computations is greater than the added computational cost associated with transforming the fixed point values into the fractional exponent domain and then also transforming the results back to the fixed point domain. Efficient implementations of transformations are discussed in further detail with respect to FIG. 4 and FIG. 5. The transformations discussed can be implemented in approximately ten processor cycles per sample for each direction of the transformation. The actual number of processing cycles depends on the specific processing unit 110.

Generally, a fractional exponent operation, which is carried out in the log domain, may be only slightly faster when the transformation into, and out of, the log domain is performed for each individual operation. Thus, a greater savings in computational complexity may be achieved when multiple operations can be performed in the log domain. That is, multiple operations may be performed on the fractional exponent values before transformation back to the linear fixed point domain.

The reduced complexity log domain computations may apply to a wide variety of DSP systems. Specifically, digital signal processing systems using fixed point DSP processors may benefit from the fixed point to fractional exponent transformations as described herein. A specific example of such a signal processing system may be a voice codec, where a block within the coder may involve searching a code book and using numerous divide operations to scale numerical values. Also such a codex may involve a gain block, which may use both square roots and divide operations. Other examples of signal processing systems may be pattern matching systems or correlation systems for estimation or prediction. Various signal processing applications require a correlation block which may benefit from reduced complexity of certain calculations using the log space transformations discussed herein.

Referring now to FIG. 3, additional details will be provided regarding the embodiments presented herein for using fractional exponent representations of values to reduce the computational complexity of numerical operations. In particular, FIG. 3 is a flow diagram illustrating aspects of a process for representing values in a fractional exponent domain according to an embodiment presented herein.

It should be appreciated that the logical operations described herein may be implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed sequentially, in parallel, or in a different order than those described herein.

The routine 300 begins at operation 310, where an input value x is given. The value x in one embodiment can be a 32-bit fixed point integer 201. However, fixed point values of other bit widths may also be used without departing from the spirit or scope of the technology discussed herein. Next, at operation 320, the value x is represented as a power of two by the expression x=2^{(i+f)}. In the foregoing expression, i is an integer and f is a fraction. The value f can take on any value greater than or equal to zero, but strictly less than one. The integer i and the fraction f may be uniquely specified such that two raised to the power of (i+f) equals the original value x. As (i+f) is an exponent of two where i is the integer exponent and f is the fractional exponent, the representation of x as 2^{(i+f)} can be considered a fractional exponent representation.

At operation 330, the value x can be transformed into the base two log domain according to the relationship y=LOG₂(x)=i+f. Here, a new value y is equivalent to the base two log of the original value x. Giving the nature of logarithms, this new value y is also equal to the exponent of two, as discussed above, or (i+f). At operation 340, i and f may be stored together as a single 16-bit value 206 where the most significant 8-bits of the 16-bit value can represent i and the lower 8-bits of the 16-bit value can represent f. This new value, or target value, is a logarithmic representation 206 of the original value x where the 16-bit value is made up of an integer exponent portion 341 in the upper 8-bits and a fractional exponent portion 341 in the lower 8-bits. While this example uses a 16-bit logarithmic representation, or 8-bits for the integer exponent 341 and 8-bits for the fractional exponent 342, any other bit width or combination of bit widths is possible.

With eight fractional bits, lookup tables used in the transformations discussed with respect to FIGS. 4-5 may contain a total of 512-bits. If the fractional bit width is increased to 9-bits, the lookup table may increase to 2,048-bits. After this, each extra bit in the fractional exponent representation can double the size of the lookup table. As such, the width of eight fractional bits can be considered a sweet spot with respect to the size of the lookup tables. The 8-bit fractional exponent portion can maintain a value that is greater than or equal to zero, but strictly less than one. If an intermediate result from a division or other computation causes the fractional portion of the exponent to become negative, a one bit borrow can occur from the integer component of the exponent into the fractional component of the exponent. This borrow can be shown by Y=[I−1]+[F+1]. Similarly, if an intermediate result causes the fractional component of the exponent to exceed one, a carry of one bit from the fractional portion of the exponent into the integer portion of the exponent can occur.

The automatic borrow and carry properties of the combined integer and fractional exponent representation discussed herein can support consistent computations to be carried out using this numerical representation in the log space. These computations can be considered consistent even when operating on as a single value as there may be no additional need to store and process the integer and fractional portions separately. This simplification may also support the reduction in computational complexity. The routine 300 may terminate after operation 340.

Referring now to FIG. 4, additional details will be provided regarding the embodiments presented herein for using fractional exponent representations of values to reduce the computational complexity of numerical operations. In particular, FIG. 4 is a flow diagram illustrating aspects of a process for transforming fixed point values into fractional exponent values according to an embodiment presented herein.

The routine 400 may be used to transform an unsigned fixed point integer variable, for example, a 32-bit wide unsigned fixed point integer into a new 16-bit variable in a log space. The bit widths of 32-bits and 16-bits are merely examples and other bit widths may be used as appropriate in a given embodiment. The new variable is in the base two log domain and contains a fractional exponent component in the eight least significant bits, and an integer exponent component in the eight most significant bits.

The routine 400 begins at operation 410, where a forward lookup table is provided. The forward lookup table can have 256 values with indexes from 0 to 255. The 256 value table can be given by:

Forward_Table[0 . . . 255]=(LOG [256 . . . 512]/LOG(2))−8.

The values in the lookup table may always be between one and two, therefore it may not be necessary to store the bit indicating the integer one in the table. Thus, only the fractional bits may need to be stored within the forward lookup table. At operation 420, a 32-bit unsigned integer a is received. The 32-bit unsigned integer a may be a fixed point value that is being converted into a logarithmic space using the fractional exponent representation discussed herein. At operation 430, a value t is determined that can be equal to the number of leading zeros in the integer a. The leading zeros of the integer can be determined by identifying the bit position of the most significant high bit and then counting the number of bit positions higher than that most significant high bit. Those higher positions that are to be counted can all be bit set to low or zero.

At operation 440, an 8-bit value m can be formed from the next 8-bits after the most significant high bit of a. At operation 450, the most significant bits of m are zero padded if less than 8-bits were available from a when forming m in operation 440. At operation 460, the lookup table is accessed. The value m, that was formed in operation 450, may be used to index into the forward lookup table. At operation 470, the result of the lookup table is stored into the lower 8-bits of the 16-bit value y. In operation 480, the upper 8-bits of the 16-bit value y are determined. The upper 8-bits of the 16-bit value y are set equal to the value (31−t), where t was determined in operation 430. At operation 490, the 16-bit value y is output as the fractional exponent representation of the value a that was provided in operation 420. The routine 400 can terminate after operation 490.

Referring now to FIG. 5, additional details will be provided regarding the embodiments presented herein for using fractional exponent representations of values to reduce the computational complexity of numerical operations. In particular, FIG. 5 is a flow diagram illustrating aspects of a process for transforming fractional exponent values into fixed point values according to an embodiment presented herein.

The routine 500 may be used to convert a variable from the log domain to the linear domain. More specifically, a fractional exponent representation may be converted back to a fixed point representation. The routine 500 begins at operation 510, where a reverse lookup table can be provided. The reverse lookup table can have 256 values. The 256 values of the reverse lookup table can be given by:

Reverse_Table[0 . . . 255]=Exp(([0 . . . 255]/256.0)/1.4427).

Here, the value Exp(x) is given by e raised to the power of x, where e is the natural log base equal to approximately 2.718. The operation Exp(x) may be considered the inverse of the natural log operation on x, or the inverse of Ln(x). That is, the values in the lookup table relate to the inverse of the logarithm as expected by the nature of the transform from log to linear space. The significance of the value 1.4427 in the lookup table expression is given by the ratio LOG(e)/LOG(2)=1.4427, where the two logs are of any base, but must be of the same base. For example, they may both be the natural log or they may both be the base two log.

At operation 520, a 16-bit fractional exponent value z is received. At operation 530, the value z received in operation 520 may be separated into an integer exponent from the upper 8-bits of the value z and a fractional exponent from the lower 8-bits of the value z. At operation 540, the lower 8-bits are used to index into the reverse lookup table provided in operation 510. In operation 550, the results of the lookup can be placed into a 32-bit value b. At operation 560, the bit of b that corresponds to the integer value one is set high. At operation 570, the value in b can be bit-shifted by the integer exponent extracted from the upper 8-bits of value z in operation 530. Finally, at operation 580, the 32-bit value b can be output as the fixed point representation of the original fractional exponent value z received in operation 520. This completes the transformation from the fractional exponent log space into the fixed point integer space. The routine 500 may terminate after operation 580.

Based on the foregoing, it should be appreciated that technologies for using fractional exponent representations of values to reduce the computational complexity of numerical operations are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for storing numerical values as a logarithmic domain fractional exponent, the method comprising:
identifying a linear input value;
forming a target logarithmic variable;
storing an integer portion of a base two logarithm of the linear input value into one or more most significant bits of the target logarithmic variable; and
storing a fractional portion of the base two logarithm of the linear input value into one or more least significant bits of the target logarithmic variable.

2. The method of claim 1, further comprising supporting log domain operations on the target logarithmic variable as a single value.

3. The method of claim 1, wherein a relative positioning of the integer portion and the fractional portion support an automatic bit carry from the fractional portion to the integer portion.

4. The method of claim 1, wherein a relative positioning of the integer portion and the fractional portion support an automatic bit borrow from the integer portion to the fractional portion.

5. The method of claim 1, wherein the integer portion comprises eight bits and the fractional portion comprises eight bits.

6. The method of claim 1, wherein the linear input value comprises a thirty-two-bit unsigned fixed-point integer.

7. The method of claim 1, wherein the integer portion is based on a bit position of a most significant high bit of the linear input value.

8. The method of claim 1, wherein the fractional portion is based on a logarithm of one or more bits following a most significant high bit of the linear input value.

9. The method of claim 8, wherein the logarithm of one or more bits following the most significant high bit of the linear input value is determined from a lookup table.

10. A digital signal processing system comprising:
an input interface operable to receive a linear input value;
an output interface operable to transmit a linear output value;
a first transformation module operable to convert the linear input value into a first fractional exponent value;
a processing module operable to perform numerical operations on the first fractional exponent value resulting in a second fractional exponent value; and
a second transformation module operable to convert the second fractional exponent value into the linear output value.

11. The system of claim 10, wherein the numerical operations comprise reduced complexity log space computations.

12. The system of claim 10, wherein one or more most significant bits of the first fractional exponent value comprise an integer portion of a base two logarithm of the linear input value.

13. The system of claim 10, wherein one or more least significant bits of the first fractional exponent value comprise a fractional portion of a base two logarithm of the linear input value.

14. A computer storage medium having computer executable instructions stored thereon which, when executed by a computer, cause the computer to:
accept a linear input value;
provide a logarithmic output value;
position an integer portion of a base two logarithm of the linear input value into one or more most significant bits of the logarithmic output value; and
position a fractional portion of the base two logarithm of the linear input value into one or more least significant bits of the logarithmic output value.

15. The computer storage medium of claim 14, further causing the computer to support log domain operations on the logarithmic output value as a single value.

16. The computer storage medium of claim 14, wherein a relative positioning of the integer portion and the fractional portion support an automatic bit carry from the fractional portion to the integer portion.

17. The computer storage medium of claim 14, wherein the integer portion comprises eight bits and the fractional portion comprises eight bits.

18. The computer storage medium of claim 14, wherein the linear input value comprises a thirty-two-bit unsigned fixed-point integer.

19. The computer storage medium of claim 14, wherein the integer portion is based on a bit position of a most significant high bit of the linear input value.

20. The computer storage medium of claim 14, wherein the fractional portion is based on a logarithm of one or more bits following a most significant high bit of the linear input value.
